(19) United States
(12) Patent Application Publication
(10) Pub. No.: US 2024/0065312 A1
(43) Pub. Date: Feb. 29, 2024

(54) IGNITION SYSTEM FOR CIGARETTE STICK AND CIGARETTE STICK EQUIPPED THEREWITH

(71) Applicant: KT & G CORPORATION, Daejeon (KR)

(72) Inventors: Eunmi JEOUNG, Daejeon (KR); Na Yeon KIM, Daejeon (KR); Su In KIM, Daejeon (KR); Danbi CHO, Daejeon (KR)

(73) Assignee: KT & G CORPORATION, Daejeon (KR)

(21) Appl. No.: 18/280,119

(22) PCT Filed: Nov. 24, 2022
(86) PCT No.: PCT/KR2022/018681

§ 371 Date: Sep. 1, 2023

(30) Foreign Application Priority Data
Dec. 30, 2021 (KR) 10-2021-0192789

(51) Int. Cl. A24D 1/08; A24D 1/04; A24F 40/20; A24F 40/51

(52) U.S. Cl. CPC A24D 1/08; A24D 1/045; A24F 40/20; A24F 40/51

(57) ABSTRACT

The present disclosure relates to a conventional cigarette with a heating structure similar to that of heated tobacco by providing a heat source portion that uses a chemical reaction, and provides a cigarette stick to which an ignition system is attached and that may be fired regardless of environmental conditions of a smoking place to improve convenience of a consumer.

### TECHNICAL FIELD

The present disclosure relates to an ignition system for a cigarette stick, which includes a heat source in which a chemical reaction occurs due to catalytic stimulus, relates to a cigarette stick equipped with the ignition system, and relates to a firing device for generating the above stimulus.

### DESCRIPTION OF RELATED ART

In general, smoking articles are favorite items used by many people to relieve mental stress, and main raw materials are used by collecting only leaves from tobacco grown in the field, the collected tobacco leaves are dried and chopped to have a predetermined size, and finely powdered cocoa is mixed in a predetermined proportion to obtain tobacco powder (cut leaves) that exudes a savory taste.

Conventional cigarettes and combustible carbon heat sources are consumed by firing tip-end portions of cigarettes with an ignition source such as lighters or matches. Meanwhile, depending on climatic conditions such as windy climate or conditions of a cigarette firing portion (e.g., combustible carbon), it may be difficult to fire a cigarette with a lighter or match.

Recently, in the development of smoking articles, an aerosol generating article, so-called heated tobacco, that heats rather than burns an aerosol forming medium, such as a tobacco-containing medium, has been developed and widely used. A system employing an aerosol generating article may include, for example, a system that heats a tobacco-containing medium at 200° C. or greater to generate a nicotine-containing aerosol. A device equipped with a heating system for generating the aerosol is inevitably necessary for consumption of heated tobacco. The device is a system for evenly transferring heat to a tobacco-containing medium, and may include an internal heating device, an external heating device, and a hybrid type device. The internal heating device may heat tobacco from the inside by inserting a blade-type or needle-type heater (heating device) of the device through the inside of the tobacco-containing medium (e.g., a tobacco material) in a cigarette stick, and the external heating device may use a method of heating a tobacco material in a cigarette stick from the outside by a cylindrical heater surrounding a cigarette stick insertion space of the device.

The present disclosure has been completed to provide a dedicated firing device by attaching a heat source portion using a chemical reaction to a cigarette to apply a heating structure such as heated tobacco to a conventional cigarette, to facilitate firing and improve convenience of firing when a smoking article is consumed.

### DISCLOSURE OF THE INVENTION

### Technical Goals

The technical goal of the present disclosure is to provide an ignition system for a cigarette stick designed to allow heat to be evenly transferred to a tobacco-containing medium by applying a heating structure, such as heated tobacco, to a conventional cigarette, and provide a cigarette stick equipped with the ignition system.

In addition, another goal of the present disclosure is to provide a firing device for ignition in an ignition system for a cigarette stick.

Furthermore, the present disclosure provides a method of generating an aerosol from a tobacco-containing medium by contacting the firing device and the cigarette stick equipped with the ignition system and inducing a chemical reaction of a heat source.

However, technical goals to be achieved by the present disclosure are not limited to those described above, and other goals not mentioned above can be clearly understood by one of ordinary skill in the art from the following description.

### Effects

The present disclosure provides a conventional cigarette with a heating structure similar to that of heated tobacco by providing a heat source portion that uses a chemical reaction. In the present disclosure, it may be possible to improve convenience of a consumer by firing a cigarette regardless of environmental conditions of a smoking place.

### BRIEF DESCRIPTION OF DRAWINGS

FIG. 1 illustrates a configuration of a heat source for a cigarette stick of the present disclosure.

FIG. 2 illustrates a configuration of a cigarette stick equipped with a heat source of the present disclosure.

### BEST MODE FOR CARRYING OUT THE INVENTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

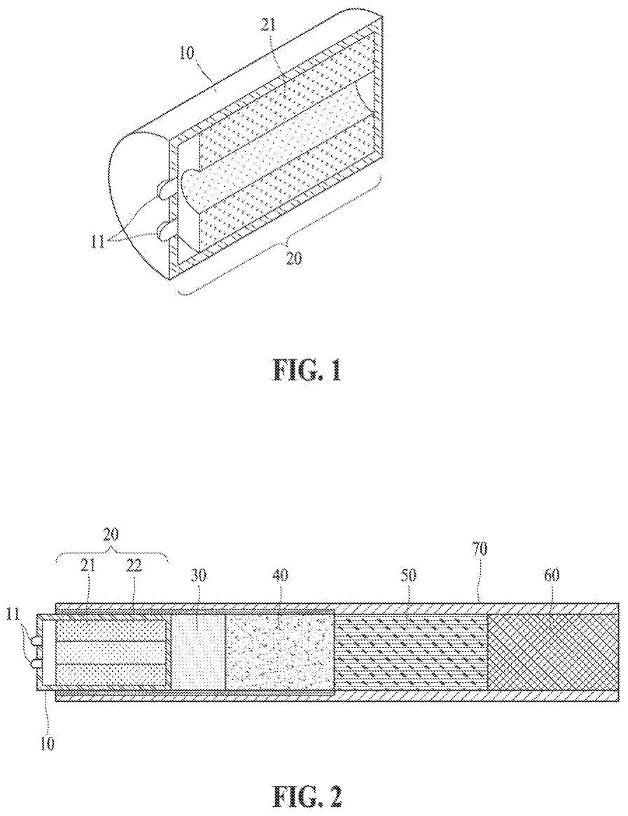

FIG. 1 illustrates an example of a configuration of an ignition system for a cigarette stick of the present disclosure.

The ignition system for the cigarette stick of the present disclosure includes a heat source portion 20 having a cylindrical shape, a metal package 10 disposed on one end face thereof, and a metal terminal 11 attached to the metal package.

The heat source portion 20 may be filled with a chemical reactant 21 or may include the chemical reactant 21.

The chemical reactant 21 may include a solid metal powder. The solid metal powder may have advantages of a high energy density and excellent stability to a reaction in comparison to liquid or gas phases. In addition, the solid metal powder may start ignition with a small amount of initial energy.

The chemical reactant 21 may include a metal reducing agent and an oxidizing agent as main raw materials.

The metal reducing agent and the oxidizing agent may be in forms of powder, and the size of the metal reducing agent and oxidizing agent may range from 0.1 to 200 micrometers (pin), desirably from 30 to 150 pin, more desirably from 50 to 100 pin.

In addition, the chemical reactant 21 may include a gelling agent and a surfactant as supplementary raw materials.

The chemical reactant 21 may include a main raw material and a supplementary raw material in a ratio of 7 to 9:3 to 1, based on a weight of each of the main raw material and the supplementary raw material.

A powder-type solid metal reducing agent included in the chemical reactant 21 may include aluminum (Al), zirconium (Zr), boron (B), tungsten (W), nickel (Ni), and titanium (Ti). The oxidizing agent in the form of powder may include all agents capable of providing oxygen during a reaction without limitation, and non-limiting examples thereof may include potassium perchlorate (KClO₄), barium chromate (BaCrO₄), potassium dichromate (K₂Cr₂O₇), iron(III) oxide (Fe₂O₃), and the like.

FIG. 2 illustrates an example of a configuration of a cigarette stick equipped with the ignition system described above.

The cigarette stick of the present disclosure may have a cylindrical shape and the above-described ignition system may be included on one side thereof. The cigarette stick may include a liquid portion 30, a medium portion 40, a cooling portion 50, and a filter portion 60 in order of proximity to the ignition system, and may include a heat transfer portion 22 to transfer heat generated in the heat source portion 20 to a medium portion.

The liquid portion 30 may contain other additives such as a flavoring agent, a moisturizing agent, and/or a cellulose acetate compound. The flavoring agent may include, for example, licorice, sucrose, fructose syrup, isosweet, cocoa, lavender, cinnamon, cardamom, celery, fenugreek, cascarilla, sandalwood, bergamot, geranium, honey essence, rose oil, vanilla, lemon oil, orange oil, mint oil, cinnamon, caraway, cognac, jasmine, chamomile, menthol, cinnamon, ylang-ylang, sage, spearmint, ginger, coriander, coffee, and the like. In addition, a wetting agent may include glycerin or propylene glycol.

Depending on the type of the medium portion, the cigarette stick of the present disclosure may not include the liquid portion 30.

The medium portion 40 may be filled with a tobacco-containing medium, and the tobacco-containing medium filled in the medium portion may be cut leaves or reconstituted tobacco. The reconstituted tobacco described above may be in the form in which a crimped sheet is folded, and may be in the form of a plurality of tobacco strands obtained by cutting a reconstituted tobacco sheet. In addition, the medium portion may be formed by combining a plurality of tobacco strands in the same direction (e.g., in parallel) or at random. A single tobacco strand may be fabricated to have a cuboidal shape with a horizontal length of 1 millimeter (mm), a vertical length of 12 mm, and a thickness (height) of 0.1 mm, however, embodiments are not limited thereto. Meanwhile, the medium portion of the present disclosure may be filled with cut leaves applied to a typical conventional cigarette.

The medium portion 40 may generate a greater amount of aerosol when filled with tobacco strands in comparison to when filled with a reconstituted tobacco sheet, and may generate a greater amount of aerosol when filled with crushed reconstituted tobacco or cut leaves in comparison to when filled with tobacco strands. Tobacco strands, rather than a tobacco sheet, and crushed granular tobacco, rather than tobacco strands, may allow heat to be transferred smoothly from the heat transfer portion 22 or the heat source portion 20 to the tobacco-containing medium in the media portion.

The cooling portion 50 may cool an aerosol generated as the heat transfer portion 22 or the heat source portion 20 heats the medium portion. Accordingly, a user may inhale the aerosol cooled to a suitable temperature. The cooling portion may be formed of polylactic acid. The cooling portion may be fabricated in various shapes to increase a surface area per unit area (i.e., a surface area in contact with an aerosol).

The filter portion 60 may be a cellulose acetate filter and may be fabricated as a recess filter including a hollow, however, embodiments are not limited thereto.

The heat transfer portion 22 may include, for example, all materials with high thermal conductivity, and non-limiting examples thereof may include a carbon material. The heat transfer portion 22 may be provided in the form of thin paper surrounding the heat source portion 20 and the medium portion 40, to transfer thermal energy provided by the heat source portion to the medium portion, similarly to an external heating electronic cigarette.

Meanwhile, a side of the cigarette stick of the present disclosure may be surrounded by an outer cigarette paper 70. The outer cigarette paper 70 may be generated by applying a predetermined material to one surface or both surfaces of a paper packaging material (or coating one surface or both surfaces of the paper packaging material with a predetermined material). Here, the predetermined material may correspond to, for example, silicon. However, embodiments are not limited thereto. Silicon may have characteristics, such as heat resistance with little change due to temperature, oxidation resistance to prevent oxidation, resistance to various chemicals, water repellency, electrical insulation, and the like. However, even when silicon is not used, any material having the above-described characteristics may be applied to (or used to coat) the outer cigarette paper 70 without limitation.

The outer cigarette paper 70 may prevent the cigarette stick from being burned. For example, when the medium portion 40 is heated by the heat transfer portion 22 or the heat source portion 20, a possibility of the cigarette stick being burned may be present. For example, when the temperature rises above an ignition point of one of materials included in the medium portion 40, the cigarette stick may be burned. Even in this example, it may be possible to prevent the cigarette stick from being burned because the outer cigarette paper 70 includes a non-combustible material.

Meanwhile, activation energy necessary for a chemical reaction may vary depending on the type and size of the metal reducing agent included in the chemical reactant in the heat source portion 20 of the present disclosure. Under conditions of the size of the chemical reactant and the type of metal reducing agents described above, the activation energy necessary for the chemical reaction may range from 0.1 and 10 millijoules (mJ).

In the present disclosure, to transfer the activation energy to the heat source portion 20, the metal package 10 including a metal terminal 11 may be positioned at one side of the heat source portion 20. The metal package may function as a heater and may evenly transfer heat inside the heat source portion in comparison to directly transferring heat to the heat source portion using a lighter, and the like.

The metal package 10 may receive electricity supplied through a separate firing device 100. Specifically, the metal terminal 11 of the metal package 10 may contact the firing device 100, to receive current applied from the firing device 100. The firing device 100 may include a small-sized battery including a capacitor with a capacitance of 10 to 300 microfarads (μF) to apply a voltage of 5 to 30 volts (V), and a constant voltage regulator.

The firing device 100 is not limited as long as it has a shape to apply current to a metal package via the metal terminal 11, and may have a shape to allow insertion of a cigarette stick of the present disclosure, similar to a commercially available heated electronic cigarette.

The firing device 100 may include a sensor portion configured to sense a temperature of the heat transfer portion 22, and may include an operating portion that may generate a signal, such as a vibration, light, or sound, when the temperature sensed by the sensor portion reaches a specific temperature.

According to an example of the present disclosure, when a cigarette stick with an ignition system is inserted into the firing device 100, a chemical reaction may occur inside the heat source portion 20 while electricity is being supplied from the ignition device through the metal terminal 11, and when the heat transfer portion 22 heated by the heat source portion 20 reaches a specific temperature, a signal, such as a vibration, light, or sound may be generated in the ignition device, and a user who senses the signal may remove the cigarette stick from the firing device 100 and inhale an aerosol through a filter portion of the cigarette stick to which the ignition system is attached in the same manner as a conventional cigarette.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

### EXPLANATION OF REFERENCE NUMERALS

Metal terminal 11
Metal package 10
Heat source portion 20
Chemical reactant 21
Heat transfer portion 22
Liquid portion 30
Medium portion 40
Cooling portion 50
Filter portion 60
Outer cigarette paper 70
Firing device 100

### INDUSTRIAL AVAILABILITY

The present disclosure may be used as a cigarette that may be fired regardless of environmental conditions of a smoking place to improve convenience of a consumer.

1. An ignition system for a cigarette stick, the ignition system comprising:
a metal package to which a metal terminal is attached; and
a heat source portion in contact with the metal package,
wherein the heat source portion comprises a solid metal and an oxidizing agent.

2. The ignition system of claim 1, wherein
the solid metal is in a form of powder, and
the solid metal is at least one selected from the group consisting of aluminum (Al), zirconium (Zr), boron (B), tungsten (W), nickel (Ni), and titanium (Ti).

3. The ignition system of claim 1, wherein
the oxidizing agent is in a form of powder, and
the oxidizing agent is at least one selected from the group consisting of potassium perchlorate (KClO₄), barium chromate (BaCrO₄), potassium dichromate (K₂Cr₂O₇), and iron(III) oxide (Fe₂O₃).

4. The ignition system of claim 1, wherein the heat source portion further comprises a gelling agent and a surfactant.

5. The ignition system of claim 1, wherein the heat source portion has a cylindrical shape.

6. The ignition system of claim 1, wherein an outer surface of the heat source portion is surrounded by a heat transfer portion having a high thermal conductivity.

7. A cigarette stick comprising the ignition system of claim 1, wherein
the cigarette stick has a cylindrical shape, and
the cigarette stick comprises:
the ignition system of claim 1 at one end thereof;
a filter portion at another end thereof;
a medium portion in contact with the heat source portion; and
a cooling portion between an end of the medium portion and an end of the filter portion.

8. The cigarette stick of claim 7, further comprising:
a liquid portion between the heat source portion and the medium portion.

9. The cigarette stick of claim 7, further comprising:
a heat transfer portion configured to surround the outer surface of the heat source portion and an outer surface of the medium portion.

10. The cigarette stick of claim 7, further comprising:
an outer cigarette paper configured to surround an outer surface of each of the heat source portion, the medium portion, the cooling portion, and the filter portion, except for the metal package,
wherein the outer cigarette paper is a paper packaging material coated with a heat-resistant material.

11. A firing device comprising a small-sized battery and a constant voltage regulator on the other surface facing an inlet through which the cigarette stick of claim 7 is inserted, the small-sized battery comprising a capacitor with a capacitance of 10 to 300 microfarads (μF) and configured to apply a voltage of 5 to 30 volts (V).

12. The firing device of claim 11, comprising:
a sensor portion configured to sense a temperature of an outer surface of the cigarette stick; and
an operating portion configured to generate a vibration, light, and/or sound signal when a specific temperature is sensed at the sensor portion.
